(19) United States
(12) Patent Application Publication
(10) Pub. No.: US 2008/0305556 A1
(43) Pub. Date: Dec. 11, 2008

(54) CHEMICAL REACTION CARTRIDGE AND METHOD OF USING THE SAME

(75) Inventors: Takeo TANAAMI, Musashino-shi (JP); Hisao KATAKURA, Musashino-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: YOKOGAWA ELECTRIC CORPORATION, Tokyo (JP)

(21) Appl. No.: 12/117,111

(22) Filed: May 8, 2008

(30) Foreign Application Priority Data
Jun. 5, 2007 (JP) 2007-148779

(51) Int. Cl. G01N 1/28; B01J 19/00

(52) U.S. Cl. 436/177; 422/99; 436/174

(57) ABSTRACT

The invention provides a chemical reaction cartridge which can be treated with safety upon introduction of a sample into the cartridge and a method of using the same. An opening section of the chemical reaction cartridge is openable and closable by a rail fastener provided inside an elastic body. When the rail fastener is released, the elastic body can be opened across the entire width. The opening section provides the cartridge with an opening having a large sectional area, which is larger than a flow path and a chamber inside the cartridge, owing to elasticity of the elastic body.

### FIELD OF THE INVENTION

The invention relates to a chemical reaction cartridge capable of causing deformation to occur to the chemical reaction cartridge upon application of an external force thereto for transferring contents thereof, thereby causing chemical reaction to proceed, and a method using the same.

### BACKGROUND OF THE INVENTION

Patent document 1 has proposed a chemical reaction cartridge comprising an elastic body having chambers and flow paths formed therein capable of causing a fluid to flow in the chambers and flow paths and inhibiting the fluid from being flown in the chambers and flow paths, and a substrate formed of a rigid body for keeping a position and a shape of the elastic body in order to particularly implement synthesis, dissolution, detection, separation and so forth of a solution, with low cost, safety and ease in accordance with a predetermined protocol without individual difference.

According to the invention of Patent document 1, the chambers and flow paths are squashed by deforming the elastic body by a roller, and so forth, and the roller and so forth are moved or inhibited to be moved in a state where the chambers and flow paths are squashed, thereby causing the fluid to flow or inhibit the fluid from being flown.

Such a chemical reaction cartridge has been also utilized as a biocartridge (biochip) for testing and analyzing DNA, RNA, proteins and so forth. There is described the invention in paragraph 0033 and FIG. 21 of Patent document 1 wherein a recess is formed at an injection port through which a sample such as blood and so forth is injected and a leaked sample is held in the recess. Upon injection of the sample, an injection needle is taken out from the cartridge. According to the invention of Patent document 1, upon collection of the sample, the sample can be appropriately transferred to a processing chamber, a reaction chamber and so forth inside the cartridge by pressing the elastic body by the roller, and so forth.

[Patent document 1] JP 2005-037368A

However, according to the invention of Patent document 1, there is less likelihood of adherence of the leaked sample to surrounding objects owing to the recess formed around a boring/pricking section upon taking out the injection needle from the cartridge. However, it does not negate the likelihood of adherence of the leaked sample to the surrounding objects, and the leaked sample is exposed to air, thereby posing a risk depending on the sample.

### SUMMARY OF THE INVENTION

The invention has been developed in view of the problems of the prior art, and it is an object of the invention to provide a chemical reaction cartridge which can be treated with safety upon introduction of a sample into the cartridge and a method of using the same.

In accordance with one aspect of the invention, there is provided a chemical reaction cartridge capable of causing deformation to occur thereto upon application of an external force thereto for transferring contents thereof, thereby causing chemical reaction to proceed, characterized in that the chemical reaction cartridge includes an opening section formed therein, said opening section having a sectional area larger than a space formed inside the chemical reaction cartridge for transferring a sample thereto, and being openable and closable, wherein the sample can be received through the opening section.

According to the chemical reaction cartridge, since the opening section formed in the cartridge has a sectional area, that is larger than a space formed inside the cartridge for transferring a sample thereto and is openable and closable, the sample can be introduced into the cartridge with ease, there is no likelihood of contamination outside the cartridge.

The opening section may be opened across substantially the entire width of the cartridge.

The opening section may be openable and closable by a rail fastener.

A solvent for dissolving the sample may be accommodated in the opening section.

In accordance with another aspect of the invention, there is provided a method of using a chemical reaction cartridge capable of causing deformation to occur thereto upon application of an external force thereto for transferring contents thereof, thereby causing chemical reaction to proceed, characterized in that the method comprises a step of introducing a sample into the cartridge through an opening section having a sectional area larger than a space formed inside the chemical reaction cartridge for transferring the sample thereto, and being openable and closable, and a step of moving the sample introduced through the opening section toward the space owing to a gravity of the sample.

In accordance with further aspect of the invention, there is provided a method of using a chemical reaction cartridge capable of causing deformation to occur thereto upon application of an external force thereto for transferring contents thereof, thereby causing chemical reaction to proceed, characterized in that the method comprises a step of receiving a solvent in an opening section having a sectional area larger than a space formed inside the chemical reaction cartridge for transferring the sample thereto, and being openable and closable, and a step of causing the sample to be dissolved by the solvent received in the opening section.

In accordance with still further aspect of the invention, there is provided a method of using a chemical reaction cartridge capable of causing deformation to occur thereto upon application of an external force thereto for transferring contents thereof, thereby causing chemical reaction to proceed, characterized in that the method comprises a step of introducing a sample into the cartridge through an opening section having a sectional area larger than a space formed inside the chemical reaction cartridge for transferring the sample thereto, and being openable and closable, and a step of executing separation between the sample and air in the opening section in a state where the opening section is closed.

According to the method of using the chemical reaction cartridge, since there is formed the opening section having a sectional area larger than a space formed inside the chemical reaction cartridge for transferring the sample thereto, and being openable and closable, the sample can be introduced into the cartridge with ease, and there is no likelihood of contamination outside the cartridge.

### BRIEF DESCRIPTION OF THE DRAWINGS

FIG. 1(A) is a vertical sectional view of a chemical reaction cartridge according to a first embodiment of the invention and FIG. 1(B) is a perspective view of the cartridge in FIG. 1(A);

FIG. 2(A) is a vertical sectional view showing a state where a sample is injected into the chemical reaction cartridge according to the first embodiment of the invention, FIG. 2(B) is a vertical sectional view showing a state where the cartridge is sealed upon injection of the sample;

FIG. 3 is a vertical sectional view of a chemical reaction cartridge according to a second embodiment of the invention;

FIG. 4(A) is a vertical sectional view showing a state where a chemical reaction cartridge according to a third embodiment of the invention is opened, FIGS. 4(B), 4(C) are vertical sectional views each showing a state where the chemical reaction cartridge is sealed.

FIGS. 5(A) and 5(B) are vertical sectional views each showing a sealing structure of a chemical reaction cartridge according to a fourth embodiment of the invention;

FIGS. 6(A) and 6(B) are vertical sectional views each showing a positioning structure of a chemical reaction cartridge according to a fifth embodiment of the invention;

FIG. 7(A) is a sectional view of a chemical reaction cartridge according to a sixth embodiment of the invention, and FIGS. 7(B) and 7(C) are perspective views of the cartridge in FIG. 7(A);

FIGS. 8(A) and 8(B) are sectional views of a chemical reaction cartridge according to a seventh embodiment of the invention; and

FIG. 9(A) is a sectional view showing a configuration of a chemical reaction cartridge having an air pocket formed therein for holding air on the air pocket, and FIG. 9 (B) is a view showing an example for adding a shutter to the chemical reaction cartridge for executing separation between a solution and air.

### PREFERRED EMBODIMENT OF THE INVENTION

A chemical reaction cartridge of the invention is now described with reference to the accompanying drawings. There are described hereinafter embodiments of the invention, and the invention is not limited to these embodiments. The chemical reaction cartridge of the invention has been applied as a reactor, which is generally called as a “microreactor”. The invention is not limited to a specific application.

### First Embodiment

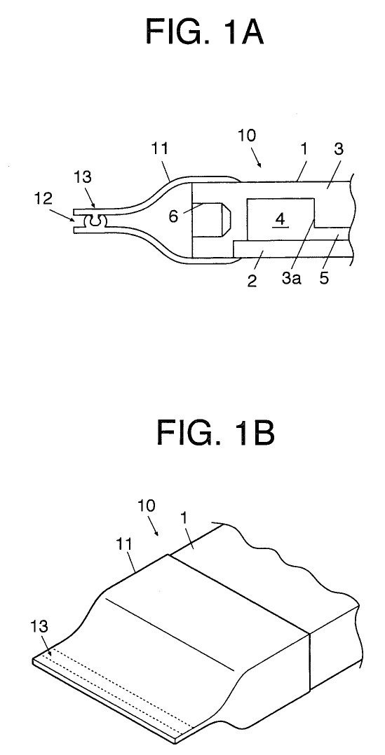

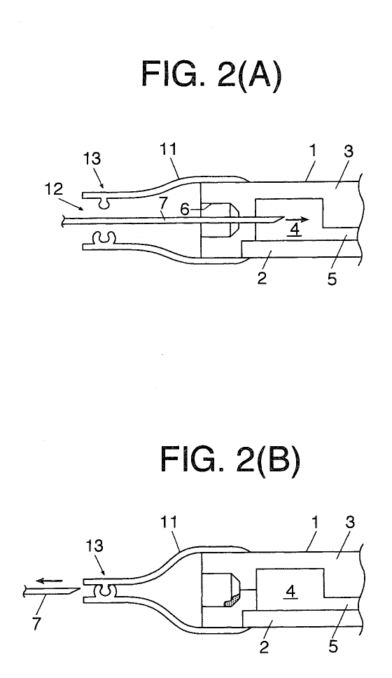

First of all, the chemical reaction cartridge of the first embodiment is now described with reference to FIGS. 1 and 2.

FIG. 1(A) is a vertical sectional view of a chemical reaction cartridge according to the first embodiment of the invention and FIG. 1(B) is a perspective view of the cartridge in FIG. 1(A).

As shown in FIGS. 1(A) and 1(B), the chemical reaction cartridge 10 comprises a cartridge body 1 and a sealing member 11 attached to an end portion of the cartridge body 1. The cartridge body 1 comprises an elastic body 3 such as an airtight and elastic rubber and a substrate 2 formed of a rigid body made of a hard material for positioning and keeping the shape of the elastic body.

As a material of the elastic body 3, there are silicon rubber, PDMS (polydimethylsiloxane), natural rubber and a polymer thereof, acrylic rubber, urethane rubber, and so forth.

As a material of the substrate 2, there are glass, metal, hard resin, or a rigid body that can be bent.

As shown in FIG. 1(A), a recess (e.g. 3a) is formed on one face of the elastic body 3. The portion other than the recess formed on one face of the elastic body is adhered to the face of the substrate 2, thereby forming a flow path and a chamber. The number of the chamber is not less than two. The flow path connects between the chambers and enables a material to be transferred between the chambers. The material to be transferred is a fluidic material, liquid and other fluidic materials. If a reaction material to be transferred is a solid material and so forth which do not flow, and a material which is difficult to flow, a solution including the reaction material is introduced into the chamber.

The flow path and chamber may be formed of an elastic body to be entirely covered therewith, or a part of the wall sections thereof may be formed of an elastic body. The flow path and chamber can be formed to be entirely covered with an elastic body by interposing an additional layer of the elastic body between the substrate 2 and the elastic body 3. Further, an elastic body may be used instead of the substrate 2, so that the cartridge may be configured without a rigid body.

Movement of the material is implemented in the following manner.

A pressing means such as a roller, a squeegee, a syringe and so forth is pressed against the elastic body 3 over the flow path or chamber to squash the flow path or chamber. When the flow path or chamber is squashed, the material inside the flow path or chamber is caused to flow to be moved. Further, the material inside the flow path or chamber is caused to flow by shifting the pressing position, thereby moving the material in the shifting direction of the pressing position. It is preferable that the shift of the pressing position is implemented by pressing the flow path or chamber until the inner space of the cartridge is rendered in a blocked state by causing opposite inner walls of the flow path or chamber to contact each other in the pressing state.

The inhibition of movement of the material is implemented by causing the opposite inner walls of the flow path or chamber to contact each other by the pressing means to block the inner space of the cartridge. If a plurality of pressing means are used, the flow path or chamber is pressed by the other pressing means in front of the transfer direction of the material while the material is moved by one pressing means, thereby inhibiting the transfer of the material ahead of the pressed position.

The movement of the material inside the cartridge body 1 can be controlled on the basis of the movement and inhibition of movement of the material, as set forth above.

The movement of the material inside the cartridge body 1 is controlled on the basis of a principle as set forth above, thereby implementing the operation for chemical reaction.

As shown in FIG. 1(A), there are formed, in the cartridge body 1, a sample collection chamber 4 and a flow path 5 connecting to the sample collection chamber 4. The flow path 5 is connected to other chamber such as a pre-treatment chamber and so forth, not shown.

A boring/pricking section 6 is formed on the end of the cartridge body 1. The boring/pricking section 6 is formed on the portion of the elastic body 3. The boring/pricking section 6 is formed in the shape of a recessed hole from the end face of the cartridge body 1, and located adjacent to the sample collection chamber 4. A bottom portion of the hole of the boring/pricking section 6 is formed to serve as a partition wall between itself and the sample collection chamber 4, wherein when the bottom portion is bored and pricked by an injection needle, a sample such as blood, and so forth can be injected. Meanwhile, in addition to blood, there is a possibility that various objects collected from a living body, nature and so forth become a sample.

A sealing member 11 is attached to the cartridge body 1 so as to cover the end of the cartridge body 1 where the boring/pricking section 6 is formed. The sealing member 11 and the cartridge body 1 are hermetically connected to each other by adhesion, welding, and so forth. The sealing member 11 has a rail fastener structure 13 as a means for sealing an opening section 12 of the sealing member 11.

When a sample is injected, as shown in FIG. 2(A), the rail fastener structure 13 is released to render the opening section 12 open. There is no need to close the opening section 12 before the injection of the sample.

Subsequently, an injection needle 7 connected to an injection syringe and so forth is inserted into the sealing member 11 through the opening section 12. Then, the bottom portion of the boring/pricking section 6 is bored and pricked by the injection needle 7, thereby causing the tip end of the injection needle 7 to pierce the sample collection chamber 4. Further, upon injection of the sample via the injection needle 7, the injection needle 7 is removed, and the rail fastener structure 13 is engaged, thereby sealing the opening section 12. As a result, the boring/pricking section 6 is sealed. It is sufficient that the opening section 12 has a size capable of receiving the injection needle 7.

As described above, the sample is introduced into the sample collection chamber 4, then the opening section 12 is quickly sealed. Thereafter, the cartridge 10 is used for testing the sample such as blood, and so forth in a state where the opening section 12 is sealed while avoiding unnecessary opening of the opening section 12. Still thereafter, the cartridge 10 is discarded in a state where the opening section 12 is sealed.

According to the cartridge of the first embodiment, since there is formed the opening section which has a sectional area larger than a space formed inside the cartridge through which a sample is transferred, and which is openable and closable, so that the sample can be introduced into the cartridge with ease.

### Second Embodiment

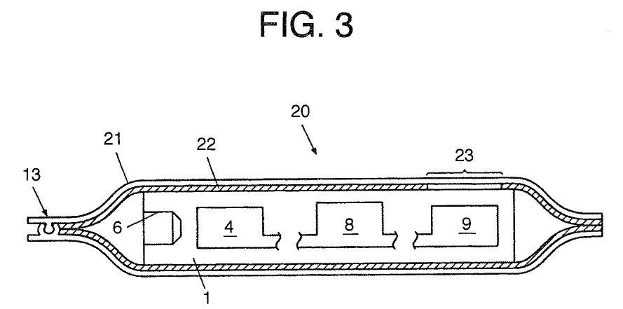

The chemical reaction cartridge of the second embodiment is now described with reference to FIG. 3.

A chemical reaction cartridge 20 comprises a cartridge body 1 and a pouched sealing member 21 for covering the entire cartridge body 1. The sealing member 21 is a pouched body which is transparent and formed of resin, and is integrally formed with a rail fastener structure 13 capable of opening and closing an opening section. Pressing of an elastic body by a roller and so forth for moving a material in the cartridge body 1 is implemented from outside the sealing member 21. Accordingly, the sealing member 21 is preferably formed of a flexible material which does not inhibit the pressing against the elastic body.

According to the cartridge of the second embodiment, since there is formed the opening section which has a sectional area larger than a space formed inside the cartridge through which a sample is transferred, and which is openable and closable, the sample can be introduced into the cartridge with ease.

There is formed a metal film 22 on an inner face of the sealing member 21. Meanwhile, it is effective to form the cartridge without forming the metal film 22. By the attachment of the metal film 22 to the sealing member 21, a light blocking effect is added to the portion where the metal film 22 is formed, and when a light is irradiated to the material accommodated in the cartridge body 1, the material accommodated in the cartridge body 1 is prevented from being changed in quality, or deteriorated, thereby improving better keeping quality. The addition of the light blocking effect can be effected by coloring the sealing member 21 and so forth without resorting to the metal film.

The metal film 22 has an opening section at a portion corresponding to a detection window section 23 so that a translucency of the detection window section 23 is ensured. A chamber 9 is a chamber for accommodating therein an object to be optically detected, such as DNA and so forth to which fluorescent material is added.

Depicted by 8 is a chamber for accommodating therein an object to be heated from outside. Thermal conductivity to the chamber 8 becomes excellent owing to the metal film 22 so that the material inside the chamber 8 can be efficiently heated. The metal film 22 may be formed isolatedly only at an area immediately above the chamber 8. There may be formed an opening section on the sealing member 21 only at the area immediately above the chamber 8 for causing the metal film 22 to be exposed outside. By so doing, thermal conductivity can be further enhanced. The metal film 22 may be provided on an outer face of the sealing member 21.

On the contrary, when the metal film at the heating portion generates thermal conduction toward its periphery, the metal film may be removed at that portion alone like the window section 23.

### Third Embodiment

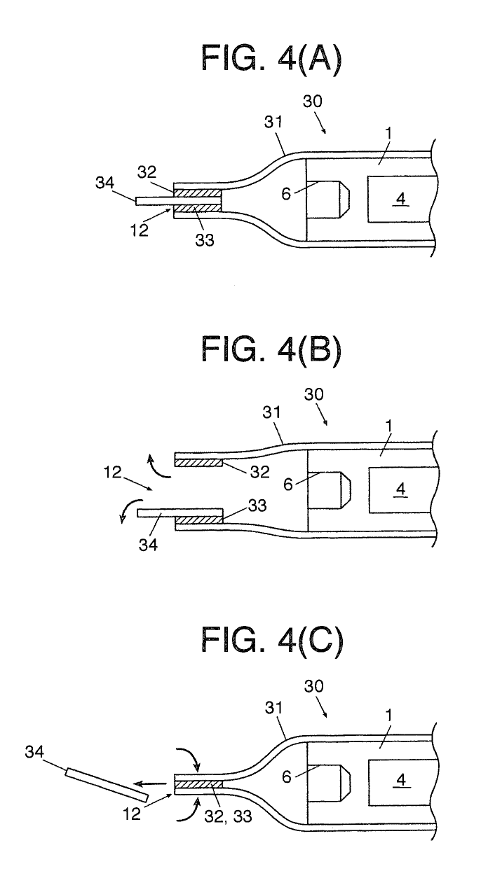

The chemical reaction cartridge of the third embodiment is now described with reference to FIGS. 4(A) to 4(C).

The third embodiment relates to a sealing means of an opening section of a sealing member, and configures other structure and a method. As shown in FIGS. 4(A) to 4(C), a chemical reaction cartridge 30 of the third embodiment has a sealing member 31 in the same manner as the first and second embodiments. There are added seal layers 32, 33 formed of an adhesion paste, or an adhesive at the opposite areas on the inner faces at an end portion of an opening section 12 of the sealing member 31. As shown in FIG. 4 (A), the seal layers 32, 33 are separated from each other by a release paper 34.

As shown in FIG. 4 (B), when either the seal layer 32 or 33 is peeled off from the release paper 34, the opening section 12 can be opened. Upon injection of a sample by opening the opening section 12, the release paper 34 is peeled off from either the seal layer 32 or 33 and removed as shown in FIG. 4(C), then the seal layers 32, 33 are subjected to pressure bonding, thereby sealing the opening section 12.

As another embodiment, an end of the sealing member 31 where the opening section 12 is present is subjected to heat sealing to thereby seal the opening section 12 without providing the seal layers 32, 33. That is, edge portions of the opening section 12 are protruded toward the opening section 12 of the sealing member 31, and the edge portions to be joined with each other are subjected to heat sealing, thereby sealing the opening section.

According to the chemical reaction cartridge of the third embodiment, since there is formed the opening section which has a sectional area larger than a space formed inside the cartridge for transferring the sample thereto, and which is openable and closable, the sample can be introduced into the cartridge with ease.

### Fourth Embodiment

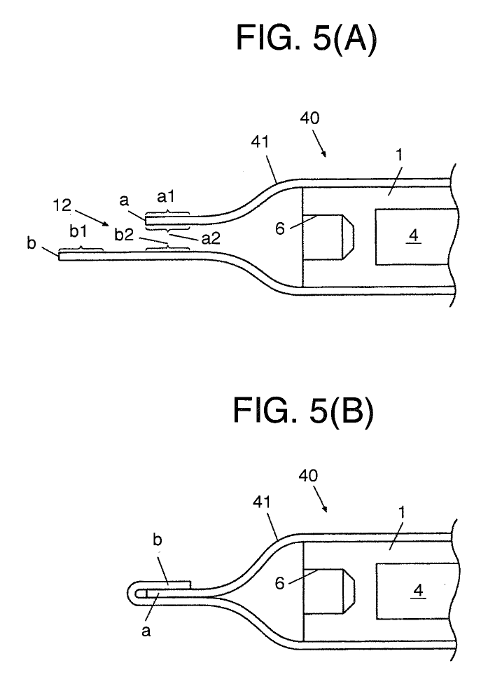

A chemical reaction cartridge of the fourth embodiment is now described with reference to FIGS. 5(A) and 5(B).

The fourth embodiment relates to a sealing means of an opening section of a sealing member, and configures other structure and a method. As shown in FIGS. 5(A) and 5(B), a chemical reaction cartridge 40 of the fourth embodiment has a sealing member 41 in the same manner as the first to third embodiments. Edge portions a, b to be joined with each other at the side of an opening section 12 of the sealing member 41 are formed to have a different length.

A seal layer formed of an adhesion paste or an adhesive is applied onto both an outer face a1 of the edge portion a and an inner face b1 of the edge portion b, and respective release papers on the seal layers are peeled off, and the sealing member 41 is bent in a state shown in FIG. 5(B), thereby sealing the opening section 12.

In addition to the configuration set forth above, seal layers formed of an adhesion paste or an adhesive are applied onto both an inner face a2 of the edge portion a and an inner face b2 of the edge portion b opposite to the inner face a2, and the opening section 12 is sealed in the same manner as made in the third embodiment, so that double sealing may be executed.

It is effective to seal the opening section 12 by subjecting the edge portions a, b to heat seal in a bending state as shown in FIG. 5(B) instead of sealing by use of the adhesion paste or adhesive. In this case, it is preferable to execute double sealing by implementing heat sealing between the outer face a1 of the edge portion a and the inner face b1 of the edge portion b, and between the inner face a2 of the edge portion a and the inner face b2 of the edge portion b opposite to the inner face a2.

According to the chemical reaction cartridge of the fourth embodiment, since there is formed the opening section which has a sectional area larger than a space formed inside the cartridge for transferring the sample thereto and which is openable and closable, the sample can be introduced into the chemical reaction cartridge with ease.

### Fifth Embodiment

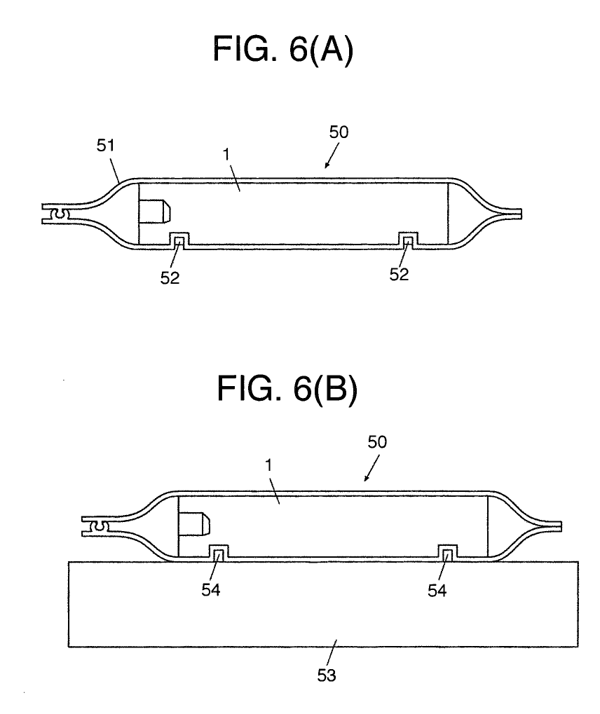

The chemical reaction cartridge of the fifth embodiment is now described with reference to FIGS. 6(A) and 6(B).

The fifth embodiment configures a structure and a method of positioning a cartridge.

A chemical reaction cartridge 50 of the fifth embodiment has a sealing member 51 in the same manner as the first to fourth embodiments. As shown in FIG. 6(A), hollow parts 52 are provided on a substrate portion at the rear face of a cartridge body 1. As shown in FIG. 6(B), the chemical reaction cartridge 50 is positioned at and fixed to a work table 53 by causing projections 54 to stand upright on the work table 53, thereby engaging the projections 54 in the hollow parts 52 of the cartridge body 1 while the sealing member 51 is intervened between the chemical reaction cartridge 50 and work table 53.

Not only the engagement between the hollow parts 52 and projections 54, but also the formation of concavity and convexity on the rear face of the substrate to be fit in the convexity and concavity on the work table may be sufficient.

According to the chemical reaction cartridge of the fourth embodiment, since there is formed the opening section which has a sectional area larger than a space formed inside cartridge for transferring the sample thereto, and which is openable and closable, the sample can be introduced into the chemical reaction cartridge with ease.

### Sixth Embodiment

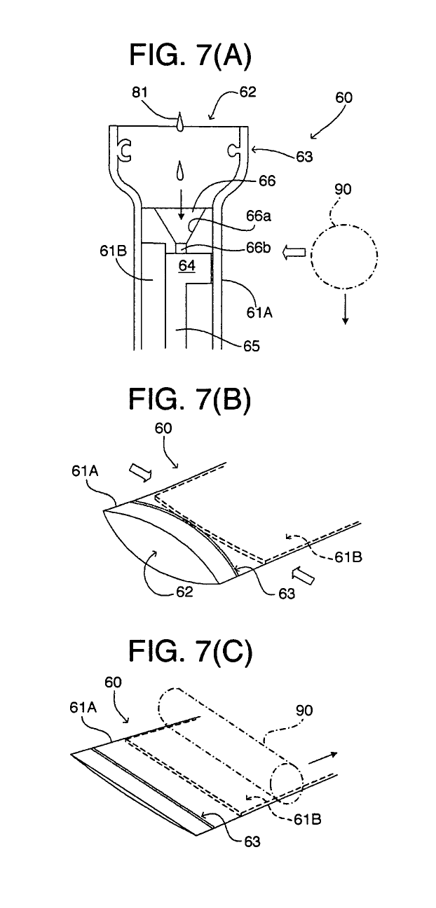

The chemical reaction cartridge of the fifth embodiment is now described with reference to FIGS. 7(A) and 7(C). The sixth embodiment shows an example for introducing a sample into the cartridge without using an injection needle.

FIG. 7(A) is a sectional view of the chemical reaction cartridge according to the sixth embodiment of the invention, and FIGS. 7(B) and 7(C) are perspective views of the cartridge in FIG. 7(A).

As shown in FIGS. 7(A) and 7(C), a chemical reaction cartridge 60 comprises an elastic body 61A formed of a material having flexibility and elasticity such as silicon rubber, PDMS (polydimethylsiloxane), natural rubber and a polymer thereof, acrylic rubber, urethane rubber, and so forth, and a substrate 61B attached to an inside of the elastic body 61A. The substrate 61B is formed of a material which is harder than the elastic body 61A.

As shown in FIG. 7(A), a recess having a predetermined shape is formed inside the elastic body 61A, thereby configuring a series of flow paths (e.g. a flow path 65) and chambers (e.g. chamber 64) for causing a predetermined chemical reaction to proceed.

As shown in FIGS. 7(A) and 7(C), an opening section 62 of the chemical reaction cartridge 60 is openable and closable by a rail fastener 63 provided inside the elastic body 61A. As shown in FIG. 7(B), when the rail fastener 63 is released, the elastic body 61A can be opened across the entire width. The opening section 62 provides the cartridge 60 with an opening having a large sectional area, which is larger than the flow path and chamber inside the cartridge 60, owing to elasticity of the elastic body 61A. Accordingly as shown in FIG. 7(B), a sample 81 can be dropped inside the cartridge 60 through the opening section 62, as shown in FIG. 7(A), by lightly pressing both end portions at both sides of the cartridge 60 as shown in FIG. 7(B).

As shown in FIG. 7(A), the dropped sample 81 is received by a receiving section 66 comprising a tapered section 66a and an introduction section 66b, subsequently introduced into the chamber 64 owing to its gravity while maintaining a posture of the opening section 62 of the cartridge 60 which is directed upward. When the opening section 62 is sealed by the rail fastener 63 upon introduction of the sample 81 into the chamber 64, the chemical reaction cartridge 60 can be sealed. Accordingly, safety of the subsequent work can be secured.

Subsequently, as shown in FIG. 7(C), a roller 9 is moved while pressing against the substrate 61B to move a fluid inside the chemical reaction cartridge 60, thereby causing a predetermined chemical reaction to proceed. Upon testing the sample and so forth, the chemical reaction cartridge 60 can be discarded in a state where the cartridge 60 is kept sealed.

As described above, according to the cartridge 60 of the sixth embodiment, since the sample can be dropped and introduced therein through the opening section 62 which is opened across the entire width thereof, it can be used as a desirable cartridge in the case of sampling a saliva, such as testing tubercle bacillus.

Further, there is no need to introduce a part of a sample which was once received by other container by use of an injection syringe. Accordingly, it is possible to eliminate viral contamination via a container, or the risk caused by work in an open system.

### Seventh Embodiment

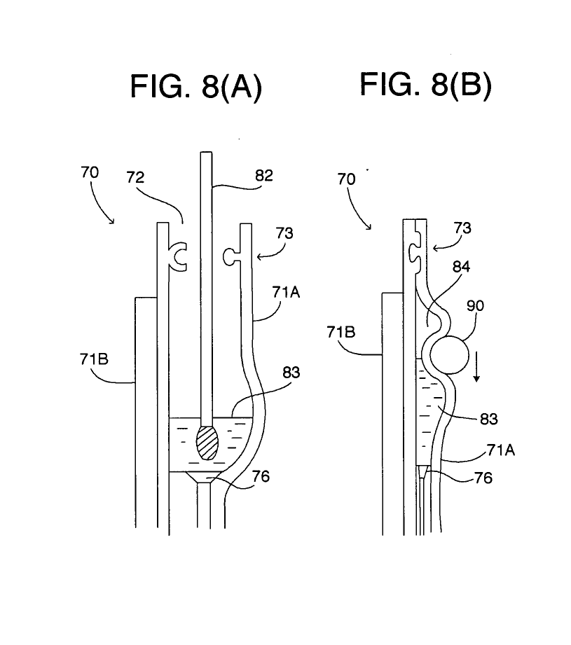

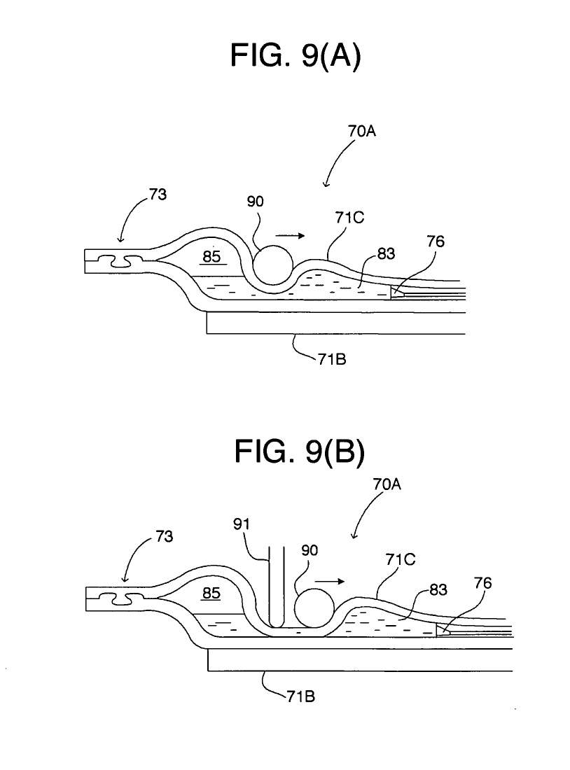

The chemical reaction cartridge of the seventh embodiment is now described with reference to FIGS. 8(A), (B) and FIGS. 9(A), (B). The seventh embodiment shows an example for introducing a sample into the cartridge by use of a sample collection rod and so forth.

FIGS. 8(A) and 8(B) are sectional views of the chemical reaction cartridge according to the seventh embodiment of the invention.

As shown in FIGS. 8(A) and 8(B), a chemical reaction cartridge 70 comprises an elastic body 71A formed of a material having flexiblility and elasticity such as silicon rubber, PDMS (polydimethylsiloxane), natural rubber and a polymer thereof, acrylic rubber, urethane rubber, and so forth, and a substrate 71B attached to an outside of the elastic body 71A. The substrate 71B is formed of a material which is harder than the elastic body 71A. A recess having a predetermined shape is formed inside the elastic body 71A, thereby configuring a series of flow paths and chambers (not shown) for causing a predetermined chemical reaction to proceed.

As shown in FIGS. 8(A) and 8(B), an opening section 72 of the chemical reaction cartridge 70 is openable and closable by a rail fastener 73 provided inside the elastic body 71A. As shown in FIG. 8(A), when the rail fastener 73 is released, the elastic body 71A can be opened across the entire width thereof. The opening section 72 provides the cartridge 70 with an opening having a large sectional area, which is larger than the flow path and chamber in the cartridge 70, owing to flexibility of the elastic body 71A. Accordingly, as shown in FIG. 8(A), a sample collection rod 82 to which a sample is adhered can be introduced into the cartridge 70 through the opening section 72, by lightly pressing both end portions at both sides of the cartridge 70 (an end portion on this side and the other end portion on the innermost side in FIG. 8(A)) in a state where the opening section 72 is largely opened.

When the sample collection rod 82 and so forth are inserted through the opening section 72 to agitate a solvent inside the cartridge 70, as shown in FIG. 8(A), the sample adhered to the sample collection rod 82 is dissolved by the solvent inside the cartridge 70, and introduced into the cartridge 70 as a solution 83. The solvent may be accommodated in advance in the cartridge 70, or it may be injected into the cartridge 70 before the sample is introduced into the cartridge 70.

When the opening section 72 is sealed by the rail fastener 73 upon completion of the introduction of the sample into the cartridge 70, the cartridge 70 can be sealed. Accordingly, safety of the work can be secured. Subsequently, as shown in FIG. 8(B), when the cartridge 70 is set on a driving unit so as to move a roller 9 while pressing against the substrate 71B, the solution 83 can be transferred inside the cartridge 70 through an introduction section 76, thereby causing a predetermined chemical reaction to proceed. Although the separation of air from the solution is needed when the solution 83 is transferred to the cartridge 70, if the solution is transferred to the cartridge 70 in a state where the cartridge 70 stands upright as shown in FIG. 8(B), air 84 can be held on an upper portion of the cartridge 70, thereby executing separation between the solution 83 and air.

Upon testing the sample and so forth, the cartridge 70 can be discarded in a state where the cartridge 70 is kept sealed.

As described above, according to the cartridge 70 of the seventh embodiment, since the sample can be introduced into the cartridge 70 by the sample collection rod 82 and so forth through the opening section 72 which is opened across the entire width of the cartridge, it can be used as a desirable cartridge in the case of sampling clumps of cells of an affected part.

Further, there is no need to introduce a part of a sample which was once received by other container by use of an injection syringe. Accordingly, it is possible to eliminate viral contamination via a container, or the risk caused by work in an open system, and also it is possible to effectively utilize the sample without wasting a part of the precious sample.

FIG. 9(A) is a sectional view showing an example of the configuration of a chemical reaction cartridge having an air pocket section for holding air thereon. In the example shown in FIG. 9(A), when a cartridge 70A is caused to set down sideways by making a change to the shape of an elastic body 71C, thereby providing an air pocket section 85 which is located at the uppermost portion of the cartridge 70A. With the provision of the air pocket section 85, even in the case of transferring the solution in a horizontal direction, air can be held on the air pocket section 85, thereby executing separation between the solution 83 and air.

FIG. 9 (B) is a view showing an example for adding a shutter to the chemical reaction cartridge for executing separation between the solution 83 and air when transferring the solution 83. In this example, when a shutter 91 is pressed against the cartridge 70A behind the roller 9, both air and the solution 83 are inhibited from being moved, thereby assisting the separation between the solution 83 and air.

What is claimed is:

1. A chemical reaction cartridge capable of causing deformation to occur thereto upon application of an external force thereto for transferring contents thereof, thereby causing chemical reaction to proceed, said chemical reaction cartridge including an opening section formed therein, said opening section having a sectional area larger than a space formed inside the chemical reaction cartridge for transferring a sample thereto, and being openable and closable, wherein the sample can be received through the opening section.

2. The chemical reaction cartridge according to claim 1, wherein the opening section is opened across substantially the entire width of the cartridge.

3. The chemical reaction cartridge according to claim 1, wherein the opening section is openable and closable by a rail fastener.

4. The chemical reaction cartridge according to claim 1, wherein a solvent for dissolving the sample is accommodated in the opening section.

5. A method of using a chemical reaction cartridge capable of causing deformation to occur thereto upon application of an external force thereto for transferring contents thereof, thereby causing chemical reaction to proceed, said method comprising a step of introducing a sample into the cartridge through an opening section having a sectional area larger than a space formed inside the chemical reaction cartridge for transferring the sample thereto, and being openable and closable, and a step of moving the sample introduced through opening section toward the space owing to a gravity of the sample.

6. A method of using a chemical reaction cartridge capable of causing deformation to occur thereto upon application of an external force thereto for transferring contents thereof, thereby causing chemical reaction to proceed, said method comprising a step of receiving a solvent in an opening section having a sectional area larger than a space formed inside the chemical reaction cartridge for transferring the sample thereto, and being openable and closable, and a step of causing the sample to be dissolved by the solvent received in the opening section.

7. A method of using a chemical reaction cartridge capable of causing deformation to occur thereto upon application of an external force thereto for transferring contents thereof, thereby causing chemical reaction to proceed, said method comprising a step of introducing a sample into the cartridge through an opening section having a sectional area larger than a space formed inside the chemical reaction cartridge for transferring the sample thereto, and being openable and closable, and a step of executing separation between the sample and air in the opening section in a state where the opening section is closed.
